(19) United States
(12) Patent Application Publication
(10) Pub. No.: US 2025/0384416 A1
(43) Pub. Date: Dec. 18, 2025

(54) Digital Assets Transfer System

(71) Applicant: Astra Engine Inc, Dover, DE (US)

(72) Inventor: Sergii Gulko, Brooklyn, NY (US)

(21) Appl. No.: 18/743,053

(22) Filed: Jun. 13, 2024

Related U.S. Application Data
(60) Provisional application No. 63/459,039, filed on Apr. 13, 2023.

(51) Int. Cl. G06Q 20/12; G06Q 20/36

(52) U.S. Cl. CPC G06Q 20/123; G06Q 20/36; G06Q 2220/00

(57) ABSTRACT

A system for a user to transfer digital assets between peers includes a plurality of peers having servers for computing data. The system further includes a software application having an Application Programming Interface for installation on a user computer, which is adapted to initiate and monitor transfers of data between the peers' using protocols. The system is characterized in that the Application Programming Interface is programmed with protocols of the plurality of peers so that a user does not require an intermediary to affect the transfer of the digital asset between the peers.

### CROSS-REFERENCE TO RELATED APPLICATIONS

This is a U.S. Nonprovisional Patent Application filed under 35 U.S.C. 111 (b) and claiming priority to U.S. Provisional Patent Application No. 63/459,039, filed Apr. 13, 2020.

### BACKGROUND OF THE INVENTION

### 1. Field of the Invention

The present invention relates to the computing industry and, more particularly to a system for transferring digital currencies between peers, such as cryptocurrency exchanges, custody providers, brokers and/or wallets.

### 2. Description of Related Art

Transferring digital assets (such as cryptocurrency) between peers (such as cryptocurrency exchanges, wallet providers, or custody providers) can be transferred by an individual. However, in institutional cases requiring the transfer of many digital assets simultaneously, an intermediary is often used. The intermediary is a trusted third party which receives the digital assets from a sender and then transfers them to a recipient. Examples of intermediaries include Copper.co (from the United Kingdom) and Fireblocks from the United States (see www.fireblocks.com).

The inventors conducted research which showed that 36% of the customers surveyed transferred digital assets on a daily basis and 14% of its customers transferred digital assets between peers (exchanges) multiple times per day; 39% of the customers surveyed were very uncomfortable transferring digital assets and 36% were quite uncomfortable. This is because 40% of the customers surveyed considered manual transfers to be risky. There is a risk that the digital asset will be misplaced or lost if the transfer is not conducted properly. 69% of customers surveyed did not use an intermediary to conduct the transfer.

Intermediaries increase the chance of success of the transfer and can assist with bulk transfers, but their service comes at a cost in terms of money and time. Entrusting an intermediary comes with a cybersecurity risk because you have to share your keys with the intermediary. If the intermediary is hacked, then the keys can be stolen. As a result, the intermediaries are often the target of hackers.

An owner of digital assets may want to transfer the digital assets between peers for many reasons. For example, to obtain a better price for a digital asset or because of a better exchange rate on a first peer compared to another. A user may not want to store all of the digital assets with one particular peer (e.g., a custody vendor or an exchange) in case the peer collapses (due to hacking or mismanagement) and therefore, a user may want to store their digital assets across multiple peers to spread their risk. Different peers may have better prices for the purchase of different digital assets.

For example, a user may have their Bitcoin cryptocurrency stored on a custody vendor Metamask and they want to sell that Bitcoin for USDT Tether on Binance, so they need to transfer their Bitcoin from Metamask to their Binance funding account. Then they will need to transfer their Bitcoin from their Binance funding account to their Binance trading account. Once they have sold the Bitcoin on Binance, they will need to transfer the proceeds from the Binance trading wallet into their Binance funding wallet and then from their Binance funding wallet back to their custody vendor Metamask (where it can be safely stored). This is a complicated series of transactions, which can become time-consuming and laborious (particularly if the user is required to perform hundreds of transfers every hour).

Different peers have different application programming interfaces which requires manual transfers. However, the transfer by the intermediary charges transfer fees (because the intermediary is acting as a middleman). This makes the transactions cost twice as much and makes the transaction twice as slow. Nevertheless, the intermediary is often necessary.

United States patent applications US20170103385 and US20170103391 describe a conventional transfer system for digital assets using an intermediary. These publications describe a digital asset settlement method which includes receiving from a first user an authorization for a conditional transaction involving a digital asset, which has been digitized on a distributed ledger, matching the authorization for transaction from the first user with an authorization for the transaction from at least one other user, settling the transaction between at least the first and other users if the conditional is met, and memorializing the settled transaction on the distributed ledger.

The object of the present invention is to provide an automated means for making multiple transactions of digital assets between peers without the need for an intermediary. Not involving an intermediary in a transaction has a substantial benefit in that the digital keys to the digital asset do not need to be entrusted to the intermediary. Even though the intermediary may be trustworthy, the intermediary could be hacked and the digital keys for the assets could be stolen.

Another object of the invention is to make transfers of digital assets cheaper, faster, easier and less risky for an owner of those digital assets.

### SUMMARY OF THE INVENTION

According to the present invention, there is provided a system for a user to transfer digital assets between peers, the system comprising:
(a) a plurality of peers having servers for computing data; and
(b) a software application having an Application Programming Interface for installation on a user computer which is adapted to initiate and monitor transfers of data between peers using protocols,
   wherein the Application Programming Interface is programmed with protocols of the plurality of peers so that a user does not require an intermediary to affect the transfer of the digital asset between the peers.

By way of analogy, instead of requiring multiple translators, the system knows multiple languages so that a translator is not required. The translators are the intermediaries who receive digital assets and transfer them to third parties (that is, the peers).

The software application may allow a user to automatically transfer a digital asset internally within accounts on a peer and externally to other peers. For example, the software application may allow a user to automatically transfer a digital asset from a funding wallet to a trading wallet on a first peer and then to a second peer for sale.

Preferably, the software application is programmed to automatically distribute digital assets evenly across peers by transferring specified amounts of the digital assets between the peers based on user-defined rules.

The software application is preferably programmed to check with a peer to ensure that digital asset was received by the peer during a transaction.

The digital assets may be cryptocurrencies (such as Bitcoin or Ethereum) or fiat currencies. The peers may be digital exchanges such as cryptocurrency exchanges, custody providers, brokers, and digital wallets. For example, Metamask, Kraken, Binance, Huobi, KuCoin, Coinbase, BitGo.

Any of the features described herein can be combined in any combination with any one or more of the other features described herein within the scope of the invention.

### BRIEF DESCRIPTION OF THE DRAWINGS

Embodiments of the invention will be described with reference to the following drawings, in which:

FIG. 1 is a schematic representation of the system of the present invention.

FIG. 2 is a representation of the dashboard page (a graphical user interface) of the system of FIG. 1.

FIG. 3 is a representation of the management page showing the configured providers (peers) used by a user of the system of FIG. 1.

FIG. 4 is a representation of the management page showing a user adding a digital wallet for digital assets to the system of FIG. 1.

FIG. 5 is a transfer page showing a digital asset being transferred on the system of FIG. 1.

FIG. 6 is a rebalancing page which implements automatic rebalancing rules for digital assets across multiple peers according to rules specified by the user.

FIG. 7 is a representation of the reports page showing a log of the transactions made by a user of the system of FIG. 1.

### DETAILED DESCRIPTION OF THE INVENTION

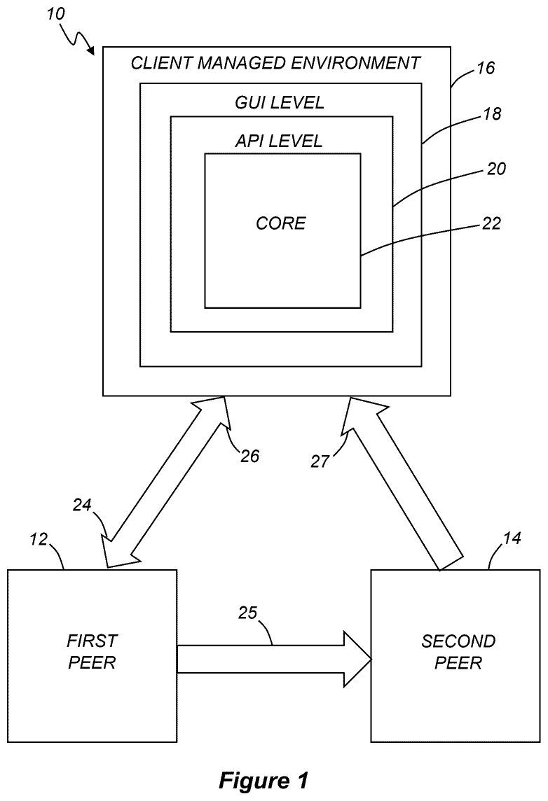

FIG. 1 shows a schematic representation of the system 10 for transferring digital assets between a first peer 12 and a second peer 14. The peers may be entities such as cryptocurrency exchanges, custody providers, brokers and/or wallets. The first peer 12 and the second peer 14 are merely representative of a plurality of potential peers that could be utilized by the system 10.

A user downloads a software application according to the present invention onto their client-managed environment 16. The software application operates at a Graphical User Interface (GUI) level 18 which controls the Application Programming Interface (API) level 20 of the software application, which controls the core 22 of the software application.

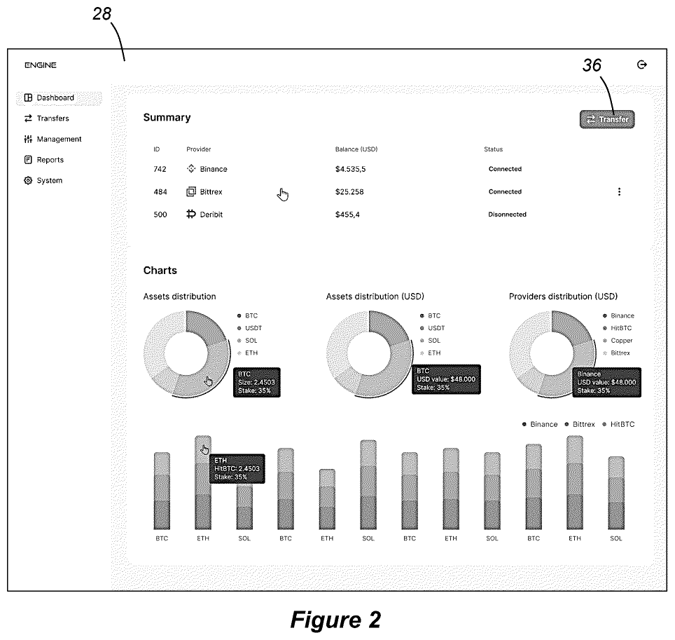

The core 22 of the software application is programmed to interface with the application programming interfaces of the peers (say, the most popular 40 peers). For example, Binance, Bittrex, and Deribit are peers which are shown in FIG. 2. However, the system could be programmed to interact with a plurality of other peers, such as: Metamask, Kraken, Huobi, KuCoin, Coinbase, or BitGo.

By way of analogy, instead of requiring multiple translators, the system knows multiple languages so that a translator is not required. The translators are the intermediaries who receive digital assets and transfer them to third parties in conventional prior art systems. These translators or intermediaries are not required in the system of the present invention, which makes transactions cheaper, faster and less risky for the user.

The system 10 enables a user to transfer a digital asset from one peer to another. The core 22 selects the application programming interface of the first peer 12 and the second peer 14. The system 10 initiates a transfer with the first peer 12 and relays the transaction status 26 back to the system 10. The system 10 then receives feedback from the second peer 14 to ensure that the digital asset was received by the second peer 14.

FIG. 2 shows the dashboard page 28 of the system 10. The dashboard page 28 lists the peers “Binance”, “Bittrex” and “Deribit” which are cryptocurrency exchanges accessed remotely by the system 10. The dashboard page 28 also has pie charts depicting the distribution of the cryptocurrencies BTC (Bitcoin), USDT (Tether), SOL (Solana), and Ethereum (ETH) in the portfolio of digital assets which are owned by the user of the system 10. The dashboard page 28 also shows the US dollar value of those digital assets and the distribution of those digital assets amongst the providers (peers) in pie charts.

FIG. 2 also shows bar graphs depicting the distribution of the digital assets of each type (e.g., BTC, ETC, SOL, and BTC) across each provider (peer).

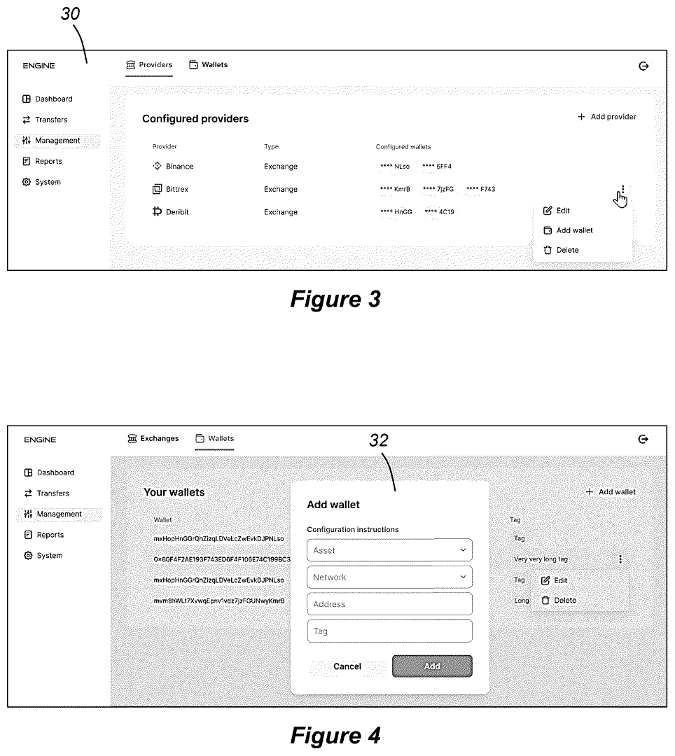

FIG. 3 shows the management page 30 of the system 10 depicting the providers (peers) which have been configured on the system 10 by the user. The user has input their wallet details for each provider in the system 10 as shown in the “Add Wallet” pop up box 32 of FIG. 4.

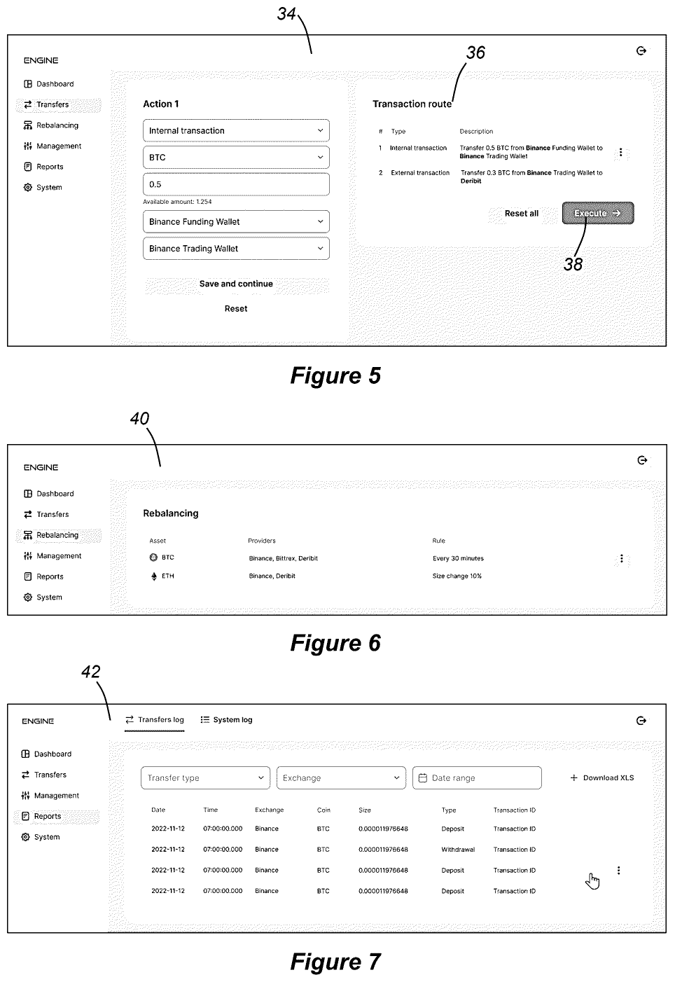

Once the digital wallets for the digital assets of the user have been included in the system 10, then the user can make a transfer via the transfer page 34 shown in FIG. 5. The transfer page 34 is activated by the transfer button 36 in the top right corner of the dashboard page 28 of FIG. 2, or via the transfers tab on site index on the left-hand side of the screen.

Transfers of digital assets can be made internally within an account of a peer, or externally between peers.

The user can specify which sub-account to transfer the digital asset from and to. Sub-accounts may include funding or trading accounts, or other different types of wallets. Some peers (if they are exchanges) have sub-accounts and some do not. The system 10 is pre-programmed with different specifications available for each peer.

For example, in the transfer page 34 of FIG. 5, the user has specified an internal transfer of 0.5 BTC (Bitcoin) from a Binance Funding Wallet to a Binance Trading Wallet. The “Transaction route” section 36 of the transfer page 34 also shows that the user has specified an external transfer of 0.3 BTC from their Binance Trading Wallet to Deribit. The user can then select the Execute button 38 to execute the transfer.

FIG. 6 shows a rebalancing page 40 of the system 10 which implements automatic rebalancing rules for digital assets across multiple peers according to rules specified by the user. For example, the user has specified that the amount of BTC (Bitcoin) should be distributed evenly across the three providers: Binance, Bittrex, and Deribit. The user has specified that this rule is implemented every 30 minutes. Likewise, on the rebalancing page 40 of the system 10, the user has specified that the amount of ETH (Ethers) should be distributed evenly between the peers Binance and Derebit unless one of them changes in size by 10%. For example, if the user has 20 Ethers, 10 should be on the Binance exchange and 10 should be on the Deribit exchange. If the number of Ethers increases on the Binance exchange by 1 Ether, then the system 10 will automatically rebalance that digital asset across both the Binance and Deribit exchanges by sending 0.5 Ethers to the Deribit platform.

Manual rebalancing of digital assets across multiple peers is laborious, time-consuming, and usually comes at the cost of a transfer fee from an intermediary. The system 10 of the present invention avoids all of these problems.

FIG. 7 shows a report page 42 that contains a log of all transactions made by user on the system 10.

The system 10 thereby fulfills the object of the invention to provide an automated means for making multiple transactions of digital assets between peers without the need for an intermediary. This makes transactions of digital assets cheaper, faster, easier, and less risky for the user.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A system for a user to transfer digital assets between peers, the system comprising:
(a) a plurality of peers having servers for computing data;
(b) a software application having an Application Programming Interface for installation on a user computer;
(c) the software application is adapted to initiate and monitor transfers of data between the plurality of peers using protocols; and
(d) wherein the Application Programming Interface is programmed with protocols of the plurality of peers so that a user does not require an intermediary to affect the transfer of the digital asset between the plurality of peers.

2. The system of claim 1, wherein the software application allows a user to automatically transfer a digital asset internally within accounts on a first peer and externally to other peers.

3. The system of claim 1, wherein the software application allows a user to automatically transfer a digital asset from a funding wallet to a trading wallet on a first peer and then to a second peer for sale.

4. The system of claim 1, wherein the software application is programmed to automatically distribute digital assets evenly across the plurality of peers by transferring specified amounts of the digital assets between the plurality of peers based on user-defined rules.

5. The system of claim 1, wherein the software application is programmed to check with a peer to ensure that digital asset was received by the peer during a transaction.

6. The system of claim 1, wherein the digital assets are cryptocurrency.

7. The system of claim 1, wherein the digital assets are digital fiat currency.
